(19) United States
(12) Patent Application Publication
(10) Pub. No.: US 2014/0348339 A1
(43) Pub. Date: Nov. 27, 2014

(54) Earphone System and Related Method of Temporarily Increasing Volume

(71) Applicant: Transcend Information, Inc., Taipei (TW)

(72) Inventor: Yu-Liong Tseng, Taoyuan County (TW)

(73) Assignee: Transcend Information, Inc., Taipei (TW)

(21) Appl. No.: 13/901,587

(22) Filed: May 24, 2013

(51) Int. Cl. H04R 1/10

(52) U.S. Cl. CPC H04R 1/1041
USPC 381/74

(57) ABSTRACT

An earphone system with temporary volume shifting function includes a speaker receiving audio signals and converting the received audio signals into sound, the speaker having a first end and a second end therein, a first resistor electrically connected to the first end of the speaker, and a switch configured between the first resistor and the speaker to control current flowing through the first resistor to the first end of the speaker. A first current flows through the speaker to output a first volume from the speaker when the switch is deactivated by a user who does not operate the switch, and a second current flows through the speaker to output a second volume from the speaker when the switch is activated by the user who operates the switch, and the second volume is greater than the first volume.

### BACKGROUND

1. Technical Field

The invention relates to an earphone system, and more particularly, to an earphone system with a switch that, when activated, increases the volume output by the earphone system.

2. Description of the Conventional Art

With increased popularity of portable media players and mobile phones in recent years, the use of earphones has become commonplace. In the following disclosure, the term “earphones” will be used to refer to over-the-ear headphones as well as in-ear earphones or earbuds.

When using earphones, whether to listen to music, other audio files, a phone conversation, finding an appropriate volume level to listen at is crucial. Too soft of a volume and it may not be possible to easily hear the sound coming from the earphones. Too loud of a volume can damage the user's ears, and thus overly-loud volumes should be avoided as much as possible.

However, there are oftentimes changes that occur in either the noise level of the user's ambient environment or in the quality of audio signals received by the earphones, which make it necessary for the user to increase the volume of sound output through the earphones. For instance, suppose that the user is listening to music and the user later walks through a noisy environment, such as a construction site. Since the background noise level of the construction site is very high, the user will have a harder time listening to music through the earphones. As another example, suppose the user is talking on a mobile phone while using earphones to hear the other party. If the user suddenly enters an area with poor mobile phone reception, such as a tunnel or a large building, the user may not be able to hear the other party as well as before. In both of these examples, the user will likely wish to increase the volume level of sound being output through the earphones.

Depending on the earphones, portable media player, or mobile phone being used, there are several ways in which the user can change the volume level. However, each method requires the user to look for the volume adjusting mechanism, which requires the user to spend a while making the volume adjustment. This total amount of time needed to adjust the volume maybe disproportionately large compared to the total amount of time the user will actually need the increased volume. Supposing that the user only needs to increase the volume for a total of ten seconds to listen to a voice mail message, and it takes the user two seconds to raise the volume and another two seconds to later lower the volume back to its original level, then a total of four seconds were required for the volume adjusting operations to listen to a ten-second voice mail message. Thus, for situations in which the user only wishes to temporarily increase the volume level, a simpler and faster method is required.

### SUMMARY

It is therefore one of the primary objectives of the claimed invention to provide an earphone system with temporary volume shifting function for allowing a user of the earphone system to quickly and conveniently increase the volume of sound output from the earphone system.

According to an exemplary embodiment of the claimed invention, an earphone system with temporary volume shifting function includes a speaker receiving audio signals and converting the received audio signals into sound, the speaker having a first end and a second end therein, a first resistor electrically connected to the first end of the speaker, and a switch configured between the first resistor and the speaker to control current flowing through the first resistor to the first end of the speaker. A first current flows through the speaker to output a first volume from the speaker when the switch is deactivated by a user who does not operate the switch, and a second current flows through the speaker to output a second volume from the speaker when the switch is activated by the user who operates the switch, and the second volume is greater than the first volume.

According to another exemplary embodiment of the claimed invention, a method of temporarily increasing volume of an earphone system is disclosed. The method includes receiving audio signals with a speaker and converting the received audio signals into sound, and a user of the earphone system operating a switch to be activated or deactivated. Current is controlled to flow through both a first resistor and a second resistor when the switch is deactivated by a user who does not operate the switch, and the speaker outputs sound at a first volume. Current is controlled to flow through only the first resistor and not through the second resistor when the switch is activated by the user who operates the switch, and the speaker outputs sound at a second volume, the second volume being greater than the first volume.

It is an advantage that the present invention allows the user to quickly and easily temporarily increase the volume of sound output from the speaker of the earphone system by simply pressing or operating the switch. The volume level will remain at a higher level as long as the user operates the switch to keep the switch activated. When the user no longer requires the higher volume level, the user only has to simply stop operating the switch and the volume level will return to the previous lower level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a user pressing an earphone according to the present invention.

FIG. 2 is a circuit diagram of an earphone according to a first embodiment of the present invention.

FIG. 3 is a circuit diagram of an earphone according to a second embodiment of the present invention.

### DETAILED DESCRIPTION

The present invention takes advantage of a common habit of users who wear earphones, which is to push the earphones towards the user's ears when the user wishes to better hear the sound coming out of the earphones. In general, when a user pushes an earphone towards the user's ear, the earphone can be moved closer to the ear or can be inserted deeper into the ear, depending on the type of earphone being used. The net effect of this is the sound output from the earphone can better enter the user's ear, and the user may hear the sound a little more clearly. As this habit of holding an earphone against the ear is such a widely established behavior, the present invention makes use of this habit for designing the volume increasing circuitry described below.

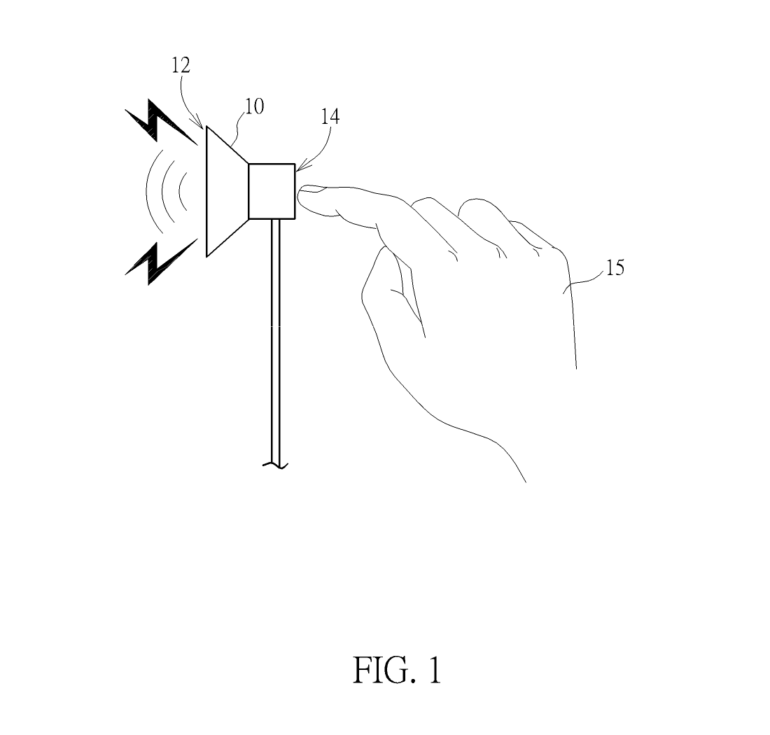

Please refer to FIG. 1. FIG. 1 is a diagram illustrating a user pressing an earphone 10 according to the present invention. The earphone 10 has a front side 12, from which sound is emitted from a speaker, and a back side 14 which the user can press with the user's finger or hand 15 in order to activate a switch that raises the volume level of the sound produced by the earphone 10.

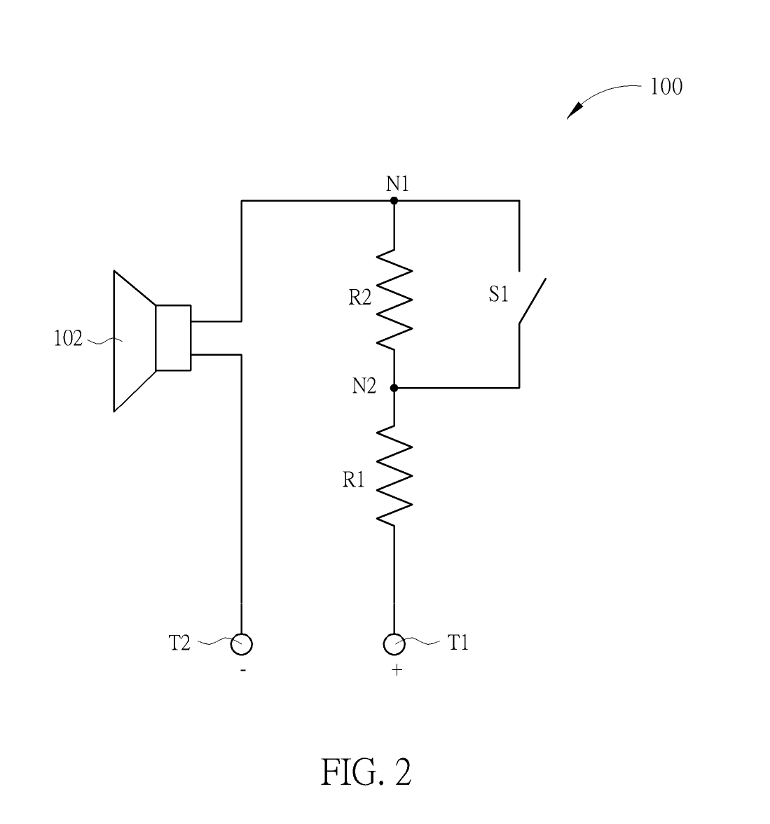

Please refer to FIG. 2. FIG. 2 is a circuit diagram of an earphone 100 according to a first embodiment of the present invention. The earphone 100 has a speaker 102 for receiving audio signals and converting the received audio signals into sound. The received audio signals are received through a positive terminal T1 and a negative terminal T2 of the earphone 100. A first end of the speaker 102 is electrically connected to node N1, and a second end of the speaker 102 is electrically connected to the negative terminal T2 of the earphone 100. A first resistor R1 is electrically connected between the positive terminal T1 and node N2. A second resistor R2 is electrically connected between node N1 and node N2, and a switch S1 is electrically connected in parallel with the second resistor R2 such that the switch S1 is also electrically connected between node N1 and node N2.

The switch S1 is preferably a pushbutton switch that is deactivated when the user does not press the switch S1 and is activated when the user presses the switch S1. In other words, when the user presses the switch S1, switch S1 is activated and allows current to flow through the switch S1, which allows current to effectively bypass the second resistor R2. In this case, current only flows through the first resistor R1, and not through the second resistor R2, as the current flows into the speaker 102. When the user does not press the switch S1, current will flow through both the first resistor R1 and the second resistor R2 as the current flows into the speaker 102. As a result of the user selectively activating or deactivating the switch S1, the amount of voltage drop across the speaker 102 will change depending on whether the current is flowing through the second resistor R2 or not. When the user does not activate the switch S1, a first current flows through the first resistor R1, the second resistor R2, and the speaker 102, and the speaker 102 outputs sound at a first volume. When the user activates the switch S1, a second current flows through the first resistor R1 and the speaker 102, and the speaker 102 outputs sound at a second volume. Since a larger proportion of the voltage drop from the positive terminal T1 to the negative terminal T2 occurs at the speaker 102 when the user activates the switch S1, the second volume produced when the switch S1 is activated is louder than the first volume produced when the switch S1 is deactivated.

When the user does not press the switch S1, the volume of sound output from the speaker 102 will remain at the first volume level. While the user presses and holds the switch S1, the volume of sound output from the speaker 102 will increase or shift to the second volume level. Then, once the user releases the switch S1, volume of sound output from the speaker 102 will return to the first volume level.

In the first embodiment shown above in FIG. 2, the first resistor R1 and the second resistor R2 can also be variable resistors, so that the relative difference between the first volume level and the second volume level can be adjusted by the manufacturer, the reseller, or the user. By adjusting the resistances of the first resistor R1 and the second resistor R2, the current levels passing through the first resistor R1 and the second resistor R2 will be altered, thereby producing different first and second volume levels. The earphone 100 can be a wired earphone, or can be a wireless earphone capable of receiving wireless audio signals through a wireless protocol such as Bluetooth.

One notable advantage of the present invention earphone 100 is the earphone 100 can be used together with any audio source device such as a mobile phone or a media player. Since no volume control signals are transmitted from the earphone 100 to the audio source device, the earphone 100 is compatible with all audio source devices. The only signal necessary is the audio signal transmitted from the audio source device to the earphone 100. If the earphone 100 is used in a single ear, then the switch S1 should be placed on that earphone 100. However, if an earphone system contains a pair of earphones to be used in two ears, only one of the two earphones needs to contain the switch S1 for adjusting the volume of the earphone system. If a switch is only provided on one of the two earphones, then a control signal can then be sent from the earphone containing the switch to the other earphone that does not contain the switch in order to adjust the volume in both earphones simultaneously. However, in no case is it necessary to send a control signal from the earphone 100 to the audio source device since the temporary volume increasing function takes place entirely within the earphone 100. The switch S1 can also be provided for each of the two earphones, so that the user can have greater control of the volume level used for each ear. Please note that the switch does not necessarily need to be pressed in order to be activated. Depending on the type of switch used, the user can activate the switch in other ways besides pressing the switch, and more detail will be described below.

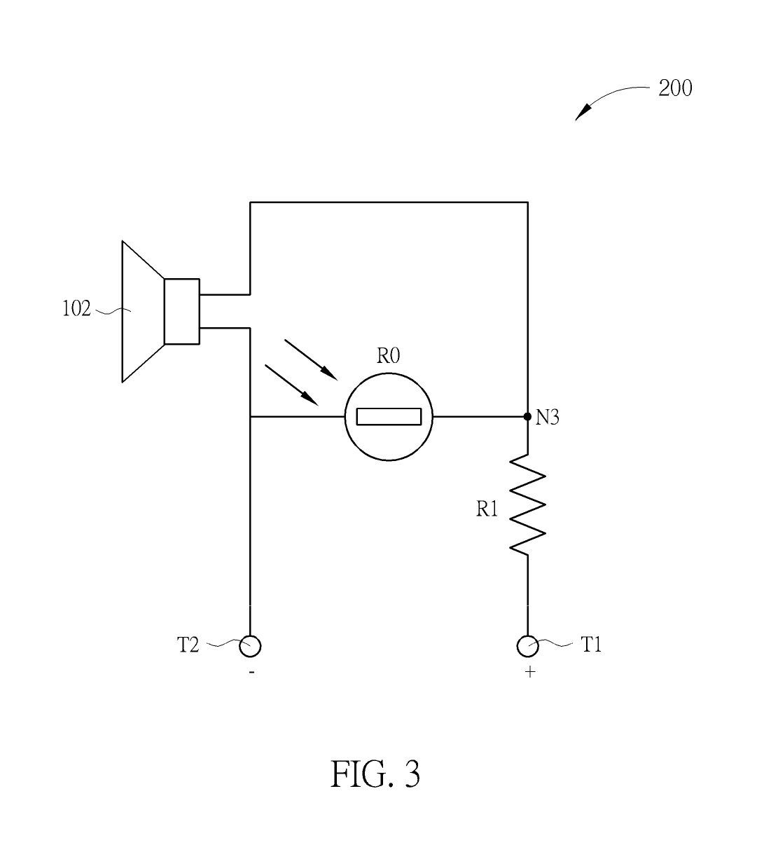

Please refer to FIG. 3. FIG. 3 is a circuit diagram of an earphone 200 according to a second embodiment of the present invention. Like the earphone 100 shown in FIG. 2, the earphone 200 of FIG. 3 also contains a positive terminal T1, a negative terminal T2, a first resistor R1, and a speaker 102. Different from the earphone 100 shown in FIG. 2, the earphone 200 of FIG. 3 replaces the switch S1 and the second resistor R2 with a photoresistor R0. The photoresistor R0 acts as both a switch and a resistor since the photoresistor R0 can be activated or deactivated by ambient light to produce a switching function, and since the photoresistor R0 produces a resistance dependent upon the amount of ambient light received.

The first end of the speaker 102 is electrically connected to node N3, and the second end of the speaker is electrically connected to the negative terminal T2. The first resistor R1 is electrically connected between the positive terminal T1 and node N3. The photoresistor R0 is electrically connected between node N3 and the negative terminal T2.

When the user of the earphone 200 does not cover the photoresistor R0, ambient light is emitted on the photoresistor R0, which causes the photoresistor R0 to conduct current. In contrast, when the user covers the photoresistor R0, the user blocks the photoresistor R0 from receiving ambient light, and prevents current from being conducted through the photoresistor R0. Consequently, the photoresistor R0 acts as an open circuit with no current flowing through the photoresistor R0 when the user covers the photoresistor R0 and blocks light from being emitted on the photoresistor R0.

When the user does not cover on the photoresistor R0, current flows through the first resistor R1, and the current flowing through the first resistor R1 will be split between the speaker 102 and the photoresistor R0. Thus, the amount of current flowing through the speaker 102 will be less than the amount of current flowing through the first resistor R1. The speaker 102 will consequently output sound at a first volume level. In contrast, when the user covers on the photoresistor R0 and prevents light from reaching the photoresistor R0, no current will flow through the photoresistor R0 acting as an open circuit. In this case, all current flowing through the first resistor R1 will also flow through the speaker 102. As a result, the speaker 102 will output sound at a second volume level, where the second volume level is higher than the first volume level. The second volume level is higher than the first volume level because of the larger voltage drop experienced across the speaker 102 when the user covers the photoresistor R0 compared to the voltage drop experienced across the speaker 102 when the user does not cover the photoresistor R0.

Other electronic devices besides the photoresistor R0 can also be used for replacing the second resistor R2. For instance, a thermistor can be used for detecting the body heat of the user when the user's finger gets near the thermistor. The thermistor conducts current at room temperature when the user's finger is not near the thermistor. On the other hand, the thermistor does not conduct current when the user touches the thermistor or when the user's finger is near the thermistor and conducts heat from the user's finger to the thermistor. Since a circuit utilizing the thermistor has the same circuit layout as the circuit utilizing the photoresistor R0, no further description is given for the sake of brevity. A touch sensor, similar to what is commonly provided in elevator buttons, can also be used. Depending on the type of switch used, the user only needs to be able to operate the switch in order to activate the switch, and the user does not necessarily need to press the switch.

The present invention contains several advantages over normal volume adjustment procedures used for normal earphones. First of all, the act of touching the back of the earphone is a natural action for users, and does not look odd to others. Furthermore, increasing the volume by touching the back of the earphone is a quick, simple, and intuitive action that does not impair the user's movement. It is fast and convenient for the user to both press and release the back of the earphone, so the user has great control over whether the volume is increased or not. Finally, the earphone is compatible with all audio source devices since no control signals are sent from the earphone to the audio source device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An earphone system with temporary volume shifting function, comprising:
a speaker receiving audio signals and converting the received audio signals into sound, the speaker having a first end and a second end therein;
a first resistor electrically connected to the first end of the speaker; and
a switch configured between the first resistor and the speaker to control current flowing through the first resistor to the first end of the speaker;
wherein a first current flows through the speaker to output a first volume from the speaker when the switch is deactivated by a user who does not operate the switch, and a second current flows through the speaker to output a second volume from the speaker when the switch is activated by the user who operates the switch, and the second volume is greater than the first volume.

2. The earphone system of claim 1, further comprising:
a second resistor configured between the first resistor and the first end of the speaker;
wherein the first current flows through the first resistor, the second resistor and the speaker when the switch is deactivated;
wherein the second current only flows through the first resistor and the speaker when the switch is activated.

3. The earphone system of claim 2, wherein the switch is a pushbutton switch that is deactivated when the user does not press the pushbutton switch and is activated when the user presses the pushbutton switch.

4. The earphone system of claim 3, wherein the pushbutton switch and the second resistor are electrically connected in parallel between the first end of the speaker and a middle node, wherein the middle node is a joint connection of the first resistor, the second resistor, and the switch, and the first resistor is electrically connected between a first terminal of the earphone system and the middle node, and the second end of the speaker is electrically connected to a second terminal of the earphone system.

5. The earphone system of claim 1, further comprising:
a second resistor configured between the first resistor and the second end of the speaker;
wherein, current flows through the first resistor, and then flows through the second resistor and the speaker respectively when the switch is deactivated, and at this moment, current flowing through the speaker is the first current;
wherein, current only flows through the first resistor and the speaker when the switch is activated, and at this moment, current of the speaker is the second current.

6. The earphone system of claim 5, wherein the switch and the second resistor are integrated as a single component in the earphone system.

7. The earphone system of claim 6, wherein the single component is electrically connected between the first end of the speaker and the second end of the speaker, the first resistor is electrically connected between a first terminal of the earphone system and the first end of the speaker, and the second end of the speaker is electrically connected to a second terminal of the earphone system.

8. The earphone system of claim 6, wherein the single component is a photoresistor, the photoresistor conducts current when receiving ambient light, and the photoresistor does not conduct current when the user covers the photoresistor and blocks the photoresistor from receiving ambient light.

9. The earphone system of claim 6, wherein the single component is a thermistor, the thermistor conducts current at room temperature, and the thermistor does not conduct current when the user touches the thermistor and conducts heat to the thermistor.

10. The earphone system of claim 1, wherein the switch is positioned on a side of the earphone system opposite to a side where sound emits from the speaker.

11. The earphone system of claim 1 being electrically connected to an audio source device and receiving the audio signals from the audio source device.

12. The earphone system of claim 11, wherein no control signals are output from the earphone system to the audio source device.

13. A method of temporarily increasing volume of an earphone system, the method comprising:
receiving audio signals with a speaker and converting the received audio signals into sound;
a user of the earphone system operating a switch to be activated or deactivated;
controlling current to flow through both a first resistor and a second resistor when the switch is deactivated by a user who does not operate the switch, and the speaker outputting sound at a first volume; and
controlling current to flow through only the first resistor and not through the second resistor when the switch is activated by the user who operates the switch, and the speaker outputting sound at a second volume, the second volume being greater than the first volume.

14. The method of claim 13, wherein the switch is a pushbutton switch that is deactivated when the user does not press the pushbutton switch and is activated when the user presses the pushbutton switch.

15. The method of claim 14, wherein the pushbutton switch and the second resistor are electrically connected in parallel between the first end of the speaker and a middle node, wherein the middle node is a joint connection of the first resistor, the second resistor and the switch, and the first resistor is electrically connected between a first terminal of the earphone system and the middle node, and a second end of the speaker is electrically connected to a second terminal of the earphone system.

16. The method of claim 13, wherein the switch and a second resistor are integrated as a single component in the earphone system.

17. The earphone system of claim 16, wherein the single component is electrically connected between a first end of the speaker and a second end of the speaker, the first resistor is electrically connected between a first terminal of the earphone system and the first end of the speaker, and the second end of the speaker is electrically connected to a second terminal of the earphone system.

18. The method of claim 16, wherein the single component is a photoresistor, the photoresistor conducts current when receiving ambient light, and the photoresistor does not conduct current when the user covers the photoresistor and blocks the photoresistor from receiving ambient light.

19. The method of claim 16, wherein the single component is a thermistor, the thermistor conducts current at room temperature, and the thermistor does not conduct current when the user touches the thermistor and conducts heat to the thermistor.
